(19) United States
(12) Patent Application Publication
(10) Pub. No.: US 2004/0182242 A1
(43) Pub. Date: Sep. 23, 2004

(54) Supporting base for gas separation membrane, producing method thereof and gas separation filter

(75) Inventors: Hiroyuki Mitani, Kobe-shi (JP); Takao Kawanaka, Kobe-shi (JP); Koji Yamamoto, Kobe-shi (JP); Takeharu Tanaka, Kobe-shi (JP); Koichi Hosoi, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 10/797,078

(22) Filed: Mar. 11, 2004

(30) Foreign Application Priority Data
Mar. 14, 2003 (JP) 2003-069421

(51) Int. Cl. B01D 53/22

(52) U.S. Cl. 96/11

(57) ABSTRACT

A supporting base of sufficient length and small diameter for supporting a gas separation membrane comprising a sintered material is provided. This supporting base has a high gas permeability, and allows omission of operation such as welding. This supporting base is produced by continuously extruding raw metal powder materials a and b corresponding to each constituent layer of the bilayer structure in the order starting from the raw metal powder material a constituting the inner layer to the raw metal powder material b constituting the outer layer such that the layer newly extruded surrounds the preceding layer to thereby produce a green cylinder of bilayer structure having an outer diameter of 15 mm or less; cutting the resulting green cylinder to a length of 100 mm or more; and sintering the green cylinder to thereby produce the supporting base for gas separation membrane. This has also enabled to provide a supporting base for a gas separation membrane comprising a sintered metal, which has a high gas permeability and which enables omission of operation such as welding is provided.

### BACKGROUND OF THE INVENTION

1. Technical Field

This invention relates to a supporting base for gas separation membrane used in producing a gas separation filter and a gas separation filter produced by using such supporting base.

2. Prior Art

Gas separation based on permselective membrane has recently captured much of the spotlight as an energy saving gas separation technology. For example, with the progress in the research of commercial use of fuel cells, production of the fuel, namely, hydrogen gas of high purity at a high efficiency has become a significant challenge. A typical method is production of hydrogen by thermal cracking of hydrocarbon gas such as town gas and natural gas, followed by the production of a high purity gas from the thus produced gas (crude gas). In this case, the crude gas produced by the thermal cracking contains not only hydrogen but also a large amount of carbon monoxide and carbon dioxide, and separation of hydrogen from such crude gas is required. One method of such separation known in the art is the method using a hydrogen permeable member (gas separation filter) which has a permeation membrane (gas separation membrane) of Pd or the like on the surface of a porous support. Selective separation of gases other than hydrogen may also be carried out by adequately selecting the gas separation membrane formed on the surface, and exemplary gas separation filters include those having zeolite membrane, carbon membrane, inorganic organic hybrid silica membrane, amorphous silica membrane, or the like on the surface.

Examples of the porous supports used in producing a gas separation filter include porous metal or ceramics produced by sintering powder, sintered metal nonwoven, foamed metal, and bulk material formed with an infinite number of pores.

On the surface of such porous support is formed a gas permselective membrane (gas separation membrane), for example, by sputtering, arc ion plating (hereinafter referred to as AIP), plating, thermal spraying, or lamination of rolled foils to thereby produce a gas permselective member (gas separation filter).

By way, the performance required for a gas separation filter is not only the selective permeation of the target gas at a high efficiency. Increase in the gas permeation per unit area, and hence, improvement in the productivity is also required for practical use of the gas separation filter in commercial scale.

Such request can be realized only by the provision of a thin and compact gas separation membrane exhibiting a high gas permeation, and commercial use of such thin gas permselective membrane requires a supporting base which supports such membrane. The performance of the membrane as a gas separation filter is largely dependent on such supporting base, and the configuration of the supporting base has a great influence on the installation capability (for example, weldability) of the gas separation filter in various apparatus and durability in the continuous operation. Accordingly, various proposals have been made for improving the supporting base of the gas separation membrane.

For example, Japanese Patent Application Laid-Open No. 62-121616 discloses a technology wherein a ceramic porous support of bilayer structure is used for the supporting base, and the surface layer (on the side in contact with the crude gas) of the supporting base is formed from a layer of sintered fine particles to thereby improve compactness of the gas separation membrane formed on its surface. However, when a ceramic material is used for the supporting base, this technology is associated with the following problems.

i) The supporting member exhibits extremely poor bonding with joint member, and this results in the difficulty of joining with other members and seal maintenance when incorporated in a gas permselective apparatus (gas separation apparatus).

ii) While reduction of the particle diameter of the ceramic porous support to the submicron level may not be difficult, this invites increase in the pressure loss in the selective separation detracting from sufficient productivity. On the other hand, when the particles with a larger size of several micrometers are used, the strength and the toughness which are critical for a supporting base become dramatically reduced, with an increased risk of cracks and chipping.

In view of the situation as described above, the applicant of the present invention conducted an extensive research and development to overcome the problems as described above, and completed an invention disclosed in Japanese Patent Application Laid-Open No. 2002-219341. This invention relates to a supporting base wherein a metal porous sintered article of multilayer structure is used for the supporting base of a gas permselective membrane. In this supporting base, the side of the gas permselective surface has a relative density of the sintered article of at least 60% and an average particle diameter of the sintered particles of at least 10 μm, and the side in contact with the crude gas has an average particle diameter of the sintered particles of up to 8 μm and maximum particle diameter of the sintered particles of up to 45 μm, and percentage of open area of at least 30%.

The supporting base for gas separation membrane disclosed in Japanese Patent Application Laid-Open No. 2002-219341 has enabled to attain high gas permeability while obviating the insufficiency in weldability and durability that have been pointed out for the conventional ceramic supporting base.

However, further improvement in productivity is required for commercialization of the gas separation apparatus, and there is a strong demand for developing a supporting base having an even higher gas permeability and which allows reduction of welding and other installation operations.

### SUMMARY OF THE INVENTION

In view of the situation as described above, an object of the present invention is to provide a supporting base for gas separation membrane wherein gas permeability has been improved over conventional products, and which comprises a sintered metal and which allows omission of operation such as welding.

The problems as described above are solved by the present invention which is directed to a supporting base for gas separation membrane comprising a multilayer cylinder of porous sintered metal; wherein the layer of the multilayer structure on the side in contact with the separated gas comprises a porous sintered metal having a relative density of at least 30% and being made of particles to be sintered having an average particle diameter of at least 10 μm; the layer of the multilayer structure on the side of the gas separation membrane formation comprises a porous sintered metal made of particles to be sintered having an average particle diameter of 8 μm or less, and a maximum particle diameter of 45 μm or less and has a percentage of open area of at least 30%; and the multilayer cylinder of porous sintered metal has an outer diameter of 15 mm or less, and a length of 100 mm or longer.

The expression “a length of 100 mm or longer” used herein means that the single article with no joint has the length of 100 mm or longer, and the “length” is not the length of the supporting base after joining two or more supporting bases by welding or the like.

In the supporting base for gas separation membrane configured as described above, the supporting base for gas separation membrane is preferably the one produced by sintering particles having an aspect ratio of less than 2.

In the supporting base for gas separation membrane configured as described above, a reaction barrier layer or a diffusion barrier layer is preferably formed on the surface of the sintered metal on the side of the gas separation membrane formation.

This invention is also directed to a method for producing the supporting base for gas separation membrane configured as described above, comprising the steps of: continuously extruding raw metal powder materials corresponding to each constituent layer of said multilayer structure in the order starting from the raw metal powder material constituting the innermost layer to the raw metal powder material constituting the outermost layer such that the newly extruded layer surrounds the preceding layer to thereby produce a green cylinder of multilayer structure; and sintering the green cylinder to produce the supporting base for gas separation membrane. The green cylinder of multilayer structure may be cut at a predetermined length before the sintering.

In the method for producing a supporting base for gas separation membrane, the raw metal powder materials corresponding to each constituent layer of said multilayer structure are preferably extruded such that the layer extruded over the preceding layer is extruded at a pressure which is the same or lower than the pressure used in extruding the preceding layer.

The present invention is also directed to a gas separation filter produced by forming a gas separation membrane on the supporting base for gas separation membrane as described above on the side of the gas separation membrane formation.

In the gas separation filter configured as described above, the gas separation membrane is selected from a metal membrane, a zeolite membrane, a carbon membrane, an inorganic organic hybrid silica membrane, and an amorphous silica membrane.

The present invention is configured as described above, and the present invention is capable of providing a supporting base for gas separation membrane comprising a sintered metal, which has gas permeability higher than conventional products, and which enables omission of welding and other operations.

### BRIEF DESCRIPTION OF THE INVENTION

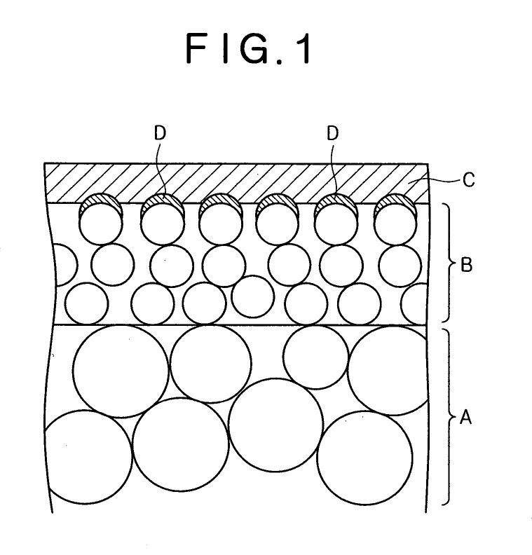

FIG. 1 is a schematic cross sectional view of the main part of the supporting base for gas separation membrane and the gas separation filter according to the present invention.

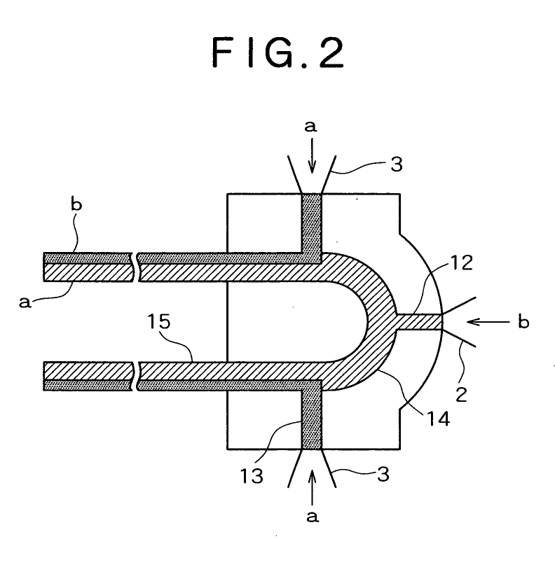

FIG. 2 is a schematic cross sectional view of the main part showing the production method of the supporting base for gas separation membrane according to the present invention.

### DETAILED DESCRIPTION OF THE INVENTION

In the supporting base comprising the sintered porous metal meeting the requirements as described above, the side that becomes in contact with the separated gas comprises a sintered layer having a relative density of at least 30% and being made of particles to be sintered having an average particle diameter of at least 10 μm; and the side of the gas separation membrane formation is made of particles to be sintered having an average particle diameter of 8 μm or less, and a maximum particle diameter of 45 μm or less, and has a percentage of open area of at least 30%. As a consequence, a gas separation filter having excellent gas permeability as well as a gas separation apparatus capable of selecting and producing the desired gas of high purity with high productivity are realized by forming the gas separation membrane on the supporting base on the side adapted for the gas separation membrane formation, namely, on the side with compactness and high percentage of open area. Since the outer diameter of the metal porous sintered article has a small outer diameter of 15 mm or less, surface area of the supporting base per unit volume can be increased to thereby improve the gas separation efficiency. The metal porous sintered article, however, may preferably have an outer diameter of at least 2 mm, and more preferably at least 4 mm since the supporting member will not be provided with the wall thickness required for maintaining the strength when the metal porous sintered article has an excessively small diameter. In addition, the porous metal sintered article has a length of 100 mm or longer, and since number of joints along the longitudinal direction can be reduced, welding and other processes can be reduced. An improved installation is thereby realized. The porous metal sintered article, however, preferably has a length of 3 m or less, and more preferably 1 m or less since handling of the an excessively long supporting base is inconvenient.

Next, the requirements as mentioned above are described in further detail.

First, the material used for producing the porous sintered article is a metal material in view of the superior environmental resistance including the oxidation resistance, ease of joining the articles in the installation, and durability in the operation of the installed apparatus. The type of the metal is not particularly limited, and use of a nonferrous metal such as titanium, nickel, aluminum, and their alloys may be contemplated. However, use of a ferrous metal is the most preferable when heat resistance, oxidation resistance, structural strength, cost, and other factors are generally taken into consideration, and the most preferable ferrous metal is stainless steel.

A supporting base has been produced by using a porous ceramic material with the prime purpose of suppressing the reaction between the gas separation membrane and the porous support. Ceramic materials, however, suffered from serious difficulty of welding and other joining means and assembly of an apparatus using an article including such ceramic supporting base has been extremely difficult. The resulting apparatus was also far from being sufficient in durability due to the lack of strength at the joints. In the present invention, the supporting base has been produced by using a sintered metal, and therefore, handling of the article in the assembly of the apparatus as well as durability of the resulting apparatus have been improved, and overall reliability of the installation in the continuous operation has also been improved.

The supporting base produced by using a sintered metal is a porous sintered article although it is made of a metal, and joining of such article by an ordinary welding technique such as TIG welding and MIG welding is likely to result in the generation of cracks and the like at and in the vicinity of the welded joint. Therefore, the supporting base produced by using a sintered metal is preferably joined by laser welding, electron beam welding, or by frictional joining and brazing, and use of brazing is most preferable since satisfactory joining is realized even at a relatively low relative density. However, even if an adequate means of joining were employed, cracks and gaps are likely to be generated at and in the vicinity of the joint when the metal porous sintered article has an excessively low relative density. In view of the situation as described above, the porous sintered article should have a relative density of at least 30% in order to prevent such defects and realize a safe and reliable joining.

As described above, the supporting base of the present invention is a porous sintered article having a multilayer structure, and typically a bilayer structure. The layer on the side where the gas separation membrane is formed does not necessarily have a relative density of 30% or higher, and the required good joining capability can be realized by designing the layer on the side in contact with the separated gas to have a relative density at least 30% since the layer on this side is the relatively thick layer which mainly contributes for the weld joining. The layer on the side of the separation membrane formation should not have an excessively high relative density since an excessively high relative density invites increase in the pressure loss and decrease in the gas permeation, and the relative density is preferably kept to the level of 90% or less, more preferably 70% or less, and most preferably 55% or less. It is to be noted that, when the layer on the side of the gas separation membrane has a relative density of 55% or less, the risk of defect occurrence in the joining of the article is relatively high, and the joining is preferably accomplished by brazing.

With regard to the pore size of the porous sintered article constituting the supporting base, the largest possible pore is preferable in view of reducing the pressure loss in the selective gas permeation. In the meanwhile, the smallest possible pore is also preferable for reliable formation of a compact and thin gas permeable membrane on the surface of the supporting base. In order to enable formation of a compact gas permeation membrane exhibiting excellent selective gas permeability with the membrane thickness of about 10 μm or less, the metal particles to be sintered on the side of the gas separation membrane formation should have an average particle diameter of 8 μm, and a maximum particle diameter of 45 μm or less.

When the average particle diameter of the particles to be sintered on the side of the gas separation membrane formation is in excess of 8 μm, many coarse pore are formed on the surface of the sintered article and the gas separation membrane formed on such surface is less likely to be a compact membrane. When the particles to be sintered on the side of the gas separation membrane formation include coarse particles with the particle diameter in excess of 45 μm, namely, when the maximum particle diameter is in excess of 45 μm, large pores are formed in the vicinity of such particles, and formation of a compact gas separation membrane becomes difficult. Therefore, the layer of the supporting base on the side of the gas separation membrane formation should be designed to be made of particles having an average particle diameter of 8 μm or less and preferably 6 μm or less, and a maximum particle diameter of 45 μm or less and preferably 30 μm or less, and to have a percentage of open area of at least 30% to thereby enable formation of a compact gas separation membrane. However, when the particles to be sintered has an excessively small particle diameter, gas permeability may become insufficient, and therefore, the average particle diameter is preferably at least 3 μm, and more preferably at least 4 μm.

As described above, in the supporting base of the present invention, formation of a compact, defect-less, thin gas separation membrane is facilitated by controlling the sintered particles on the side of the gas separation membrane formation to be made of particles having an average particle diameter of 8 μm or less and more preferably 6 μm or less, simultaneously with a maximum particle diameter of 45 μm or less. However, when the entire particles to be sintered for the porous sintered article constituting the supporting base has an average particle diameter of 8 μm or less, pressure loss of the supporting layer will be unduly high, and gas permeability will be dramatically reduced to detract from the object of improving the productivity.

The pressure loss can be reduced by reducing the thickness of the supporting base. However, decrease in the thickness of the supporting base is likely to adversely affect the strength required as a thin film-supporting base and joining by the welding. Accordingly, the supporting base should have a thickness of at least about 1 mm. In view of the situation as described above, an attempt has been made in the present invention to meet the requirement of maintaining the strength and weldability required for a thin film-supporting base, and at the same time, the requirement of suppressing the pressure loss to the lowest possible level and realizing a sufficient gas permeation, and such requirements are fulfilled by controlling the particles to be sintered for the metal porous sintered article on the side of the gas separation membrane formation to be made of particles having an average particle diameter of 8 μm or less and a maximum particle diameter of 45 μm or less, and the particles to be sintered on the side of in contact with the separated gas to have an average particle diameter of at least 10 μm (and preferably at least 15 μm, and preferable upper limit of about 30 μm or less for realizing the structural strength as a supporting layer), and a relative density of at least 60%.

Furthermore, even if the pressure loss of the supporting base were suppressed and the thickness of the gas separation membrane were reduced to an extreme degree, sufficient gas permeability will not be attained as long as the surface of the sintered article constituting the supporting base on the side of the gas separation membrane formation has an insufficient percentage of open area, since the effective gas permselective surface of the gas separation membrane will be blocked by the pore-less area on the surface of the supporting base. Accordingly, in order to provide sufficient gas permeability by overcoming the situation as mentioned above, the surface of the supporting base on the side of the gas separation membrane formation should have a percentage of open area of at least 30%, and preferably at least 35%.

In addition, if the sintered article has an excessively large outer diameter, surface area of the sintered article in relation to the unit volume of the sintered article, and hence, surface area of the gas separation membrane in relation to the unit volume will be reduced, and an excessively large gas separation apparatus will be required to achieve the predetermined gas permeation (to produce predetermined volume of the gas product). Therefore, the outer diameter of the sintered article should be limited to 15 mm or less in order provide sufficient surface area of the gas separation membrane while avoiding undesirable increase in the size of the gas separation system.

In addition, when the sintered article is too short, increase in the number of joints along the longitudinal direction will be required to achieve the predetermined gas permeation (to produce predetermined volume of the gas product), and this will adversely affect the installation convenience due to the increased welding operation and the like. Therefore, the length of the sintered article should be at least 100 mm to realize sufficiently convenient installation by reducing the welding operation and the like.

FIG. 1 is an exploded cross sectional view of the gas separation filter of the present invention which comprises the supporting base and the gas separation membrane formed on the surface of the supporting base. FIG. 1 shows the most typical configuration with a bilayer structure.

More specifically, the supporting base shown in FIG. 1 comprises sintered layer (layer B) constituting the layer on the side of the separation membrane and the sintered layer (layer A) constituting the layer on the side in contact with the separated gas.

As described above, layer A comprises a sintered material comprising the sintered particles having a particle diameter of at least 10 μm with relatively large size spaces between the particles, and therefore, this layer mainly acts as a supporting layer with a low gas flow resistance and a small pressure loss. This layer A is also designed to have a relative density of at least 30% to enable reliable and easy connection by welding. More preferably, the relative density is at least 40%. However, the relative density should be 90% or less, and more preferably 85% or less since an excessively high relative density invites undesirable increase in the pressure loss, and hence, decrease in the hydrogen permeation.

As described above, layer B, on the other hand, constitutes the layer on the side of the gas separation membrane formation, and therefore, the particles to be sintered has an average particle diameter of 8 μm or less and a maximum particle diameter of 45 μm or less to enable easy and reliable formation of a compact gas separation membrane which is free from defects. In addition, this layer is designed to have a percentage of the open area of at least 30%, and more preferably at least 35% to secure sufficient hydrogen permeation.

In both layers A and B, when the sintered particles constituting the sintered layers have an excessively high aspect ratio (namely, the ratio of the major diameter/the minor diameter), and in other words, when the particles are in the form resembling a fiber, the layer will exhibit reduced percentage of open area and poor gas permeability. This is particularly notable when the layers to be sintered are formed by extruding the raw materials for the sintered article as will be described below, since the major axis (i.e. the axis extending in the direction of the major diameter) of the fiber-like particles will align with the direction of the extrusion (which is perpendicular to the direction of the gas permeation) to fill the spaces and further inhibit the gas permeation. Accordingly, the particles constituting the sintered article should have an aspect ratio of less than 2.

In the supporting base comprising such sintered bilayer structure, the layer A is the layer which mainly ensures the structural strength of the supporting base and which enables connection between the supporting bases by welding. The thickness of the layer A is preferably at least about 0.5 mm, and more preferably, at least about 0.7 mm. While no particular upper limit is set for the layer A, a thickness of about 1 mm is sufficient in reliably realizing the structural strength and the weldability, and the thickness is preferably about 1.5 mm or less, and more preferably about 1.2 mm or less. The thickness of the layer A in excess of such range only contributes for increase in the weight and economical disadvantage. In the meanwhile, the layer B is a layer which is provided for the purpose of enabling formation of compact gas separation membrane free from defects, and this layer B is not so much expected to provide the structural strength and the weldability. Accordingly, a relatively thin layer of about 50 μm or less can fully accomplish its required function. The thickness of layer B is also preferably designed to be about 200 μm or less, and more preferably about 100 μm or less since an excessively thick layer B may invite undesirable increase in the gas flow resistance, and hence, reduced gas permeability.

In the present invention, it is required that the side of the layer A comprises a layer with a reduced gas flow resistance which mainly provides structural support and weldability, while the side of the layer B comprises a compact layer with a high percentage of open area. Accordingly, the supporting base is not limited to the one having the bilayer structure as shown in FIG. 1 comprising the layers A and B and as long as the requirements as summarized above are fulfilled, the supporting base may have a multilayer structure wherein one or more layers are provided between layers A and B so that these intervening layers have the air flow resistance and the relative density which are in between those of the layers A and B. When the supporting base has a multilayer structure, it may have a graded structure wherein the gas flow resistance and the relative density continuously vary from the side of the layer A to the side of the layer B.

Next, the method for producing the sintered metal of multilayer structure fulfilling the requirements as described above is described.

As described above, the supporting base of the present invention is an cylindrical article with substantial length and small diameter, and production of such article by conventional powder compaction method (see Japanese Patent Application Laid-Open No. 2002-219341, paragraphs [0036] to [0041]) or CIP (cold isostatic press) is difficult. More specifically, powder compaction requires a mold which has a filling depth of two to three times deeper than the molded article, and production of a long article having a length of 100 mm or more is practically impossible. In the case of CIP, the load is applied by the intervening rubber mold, and production of a lengthy article of small diameter is not possible due to the reduced compression force in the axial direction.

In contrast, a long article of small diameter can be readily produced by using the extrusion molding as shown in FIG. 2. FIG. 2 is the case wherein a supporting base of bilayer structure comprising an exterior layer and an interior layer is produced by a die 1. The bilayer structure is produced by the die 1 from the raw materials which will be formed into the layers of the supporting base. The raw materials are supplied into the die 1 from the nozzles 2 and 3. The die 1 is provided with the nozzles 2 and 3; raw material inlets 12 and 13 respectively in communication with the nozzles 2 and 3; and a passage 14 which is in communication with these raw material inlets 12 and 13 and an outlet 15 on the surface of the die 1 having an annular cross section. The passage 14 in the form of a cylinder has an outer diameter of 15 mm or less. The raw material inlets 12 and 13 are connected to the exterior side of the cylindrical passage 14 with the raw material inlet 12 on the upstream side and the material inlet 13 on the downstream side.

The diameter of the sintered particles is substantially determined by the particle diameter of the metal particles (metal powder) used as the starting material in the sintering since the size of the metal particle does not significantly change in the course of the sintering wherein adjacent metal particles become bonded to each other by the diffusion of the component in limited area on the surface of the metal particles. Therefore, raw material a produced by kneading a mixture of metal particles having an average particle diameter of 8 μm or less and a maximum particle diameter or 45 μm or less with a binder and distilled water, and raw material b produced by kneading a mixture of metal particles having an average particle diameter of 10 μm or more with a binder and distilled water are used. The binder used may be those which are used in conventional extrusion molding such as cellulose, Metolose, and wax. In order to improve dispersion of the metal particles and the binder, kneading of the mixture is preferably carried out in vacuum with deaeration.

The raw material b is continuously introduced through the nozzle 2 and the raw material a is continuously introduced through the nozzle 3 by an extruder (not shown) to supply the materials into the raw material inlets 12 and 13, respectively. The raw material b supplied to the raw material inlet 12 is filled in a cylindrical passage 14, and then pushed toward the outlet 15. In the meanwhile, the raw material a supplied to the raw material inlet 13 is also pushed into the passage 14 to surround the preceding layer of the raw material b, and the resulting bilayer structure is extruded from the outlet 15 to thereby continuously form a green cylinder of bilayer structure having an outer diameter of 15 mm or less.

In the extrusion molding as described above, the pressure (ejection pressure) P1 at which the raw material b is ejected from the nozzle 2 and the pressure (ejection pressure) P2 at which the raw material a is ejected from the nozzle 3 preferably meet the relation P1≧P2. When P1<P2, the amount of the raw material b supplied will be excessive compared to the amount of the raw material a supplied, and the exterior layer will be too thick resulting in the poor gas permeability of the sintered article. The thickness of the layers of the bilayer structure may be adjusted by adequately varying the ejection pressures P1 and P2 under the condition of P1≧P2. The specific values of the ejection pressures P1 and P2 may differ by the particle diameter of the metal powder in the raw material and the content of the binder. The ejection pressures P1 and P2, however, may be adjusted, for example, such that the ratio of P2/P1 is in the range of 0.5 to 1.0 since the exterior layer can not be supplied at an excessively low P2.

Japanese Patent Application Laid-Open No. 59-224309 discloses a method for producing a composite ceramic tube wherein a plurality of ceramic raw materials are consecutively extruded such that the layer newly extruded surrounds the preceding layer to there by produce the cylinder. In this method, the ejection pressure of the raw material is designed such that the exterior layer is ejected at a higher ejection pressure. It is estimated that the exterior layer is ejected at a higher pressure since the strength of the complex ceramic tube is provided by the exterior layer and the exterior layer needed considerable thickness.

In contrast, thickness of the layers are controlled in the present invention in view of the necessity of realizing gas permeability of the exterior layer, namely, by the concept entirely different from the prior art (Japanese Patent Application Laid-Open No. 59-224309) as described above.

The thus extruded green cylinder of bilayer structure is cut at an adequate length of at least 100 mm, and after the drying, the cylinder is sintered to produce the sintered article of the present invention.

The relative density of the sintered article on the side in contact with the separated gas and the percentage of open area on the side of the gas separation membrane formation may be adjusted by controlling the amount of the binder added to the raw material. Such parameter can be controlled not only by adjusting the binder content but also by adding beads and the like formed from an organic material.

In the production method of the present invention, use of a binder with higher viscosity may result in the reduced fluidity in the extrusion, and hence, in the higher risk of large pores (defects) formed on the surface of the molded article. When large pores of 10 μm or more are present on the surface of the molded article, formation of a compact thin film of 10 μm or less becomes difficult, and a gas separation membrane with pinholes will be produced. When the gas separation membrane has pinholes, the gas will leak through the pinholes and the separated gas will suffer from insufficient purity. When the film is formed to a thickness of 10 μm or more, gas permeability will be reduced while the number of pinholes may be reduced. Since the raw materials a and b have consistent particle diameter, the membrane is likely to suffer from pinholes, and use of a binder with a relative low viscosity is necessary. For example, when the binder used is Metolose, pinhole generation can be prevented by using Metolose of the type having low viscosity. The viscosity should be reduced to 12000 mPa.s or less by using a 2% aqueous solution of the binder.

The method for producing a green cylinder of three or more layers is not fundamentally different from the method as described above, and the number of nozzles to which the raw materials are supplied, and the number of raw material inlets formed in the die 1 can be increased depending on the number of layers constituting the cylinder.

In the embodiment as described above, the exterior layer (formed from the raw material a) is the layer on the side of the gas separation membrane formation, and the interior layer (formed from the raw material b) is the layer in contact with the separated gas. In forming the gas separation membrane on the supporting base, it is easier to form the gas separation membrane on the exterior layer, and such constitution of the exterior and the interior layers is preferable. The present invention, however, is not limited to such embodiment, and the supporting base may be configured such that the interior layer is the layer on the side of the gas separation membrane and the exterior layer is the layer in contact with the separated gas. In such a case, the pressure P1 at which the raw material a is ejected from the nozzle 2 (on the interior side) and the pressure P2 at which the raw material the raw material b is ejected from the nozzle 3 (on the exterior side) preferably meet the relation P2≧P1.

The preferable molding pressure (ejection pressure of the raw material) and the sintering temperature may differ, for example, depending on the type of the metal used. In the case of using a stainless steel powder which is the most typical material, the molding pressure (the ejection pressure of raw material) is preferably in the range of 1 MPa to 18 MPa, and more commonly, 3 MPa to 15 MPa. As will be demonstrated in the Examples, when the molding pressure is excessively low, the ratio of the constituent layers will be unstable, and when the molding pressure is excessively high, wall thickness of the green cylinder will be unstable.

The article molded from the raw material is soft and liable to deformation. Therefore, the molded article is dried before the sintering for solidification by drying. The drying may be effected by rotating the molded article with a roller drier or the like to thereby prevent deformation and eccentricity of the molded article and to maintain the straightness.

The sintering is effected at a sintering temperature of 800° C. to 1000° C., and more commonly, at 850° C. to 950° C., after the debinding heat treatment at a temperature of 200° C. to 600° C. The debinding and the sintering may be carried out as different steps, or in a continuous step. When the sintering temperature is too low, the sintering may not be completed, or the sintering may take an unduly long period. When the sintering temperature is too high, the sintering will proceed too far to result in an increased relative density or an unduly increased shrinkage during the sintering, and hence, deformation. The extrusion molding and the sintering may be carried out in a nonoxidizing atmosphere to prevent oxidation of the metal powder and sintering failure.

In forming gas separation membrane C on the surface of the layer B of the supporting base, a reaction barrier layer or a diffusion barrier layer D is preferably formed on the surface of the layer B before the formation of the gas separation membrane C since there is a risk that the metal component constituting the supporting base reacts with the substance constituting the gas separation membrane C, and diffusion of the metal component toward the gas separation membrane C may take place to deteriorate the gas perm selectivity of the gas separation membrane C.

Exemplary such diffusion barrier layer include a layer of the oxide of the sintered metal and other ceramic layers. The former oxide layer may be formed by oxidizing the sintered article, and the latter ceramic layer may be formed by coating any ceramic material by sputtering, ion plating, sol-gel method, or the like. The oxide layer formed when the sintered article comprises stainless steel is the one wherein the main components are oxides of Cr, Fe, and Mn. The Mn content is preferably controlled to 40% by mass or less since the Manganese oxide with the Mn content in excess of 40% by mass is likely to experience loss of diffusion barrier function with time due to gradual loss of the Manganese oxide.

Other types of the ceramic material used for the diffusion barrier layer may be any of oxides, nitrides, carbides, and borides, and the preferred in view of the ease of formation and excellent barrier function are iron oxide, chromium oxide, aluminum oxide, chromium nitride, and the like. In the formation of the diffusion barrier layer, it is preferable to first oxidize the surface of the sintered article to thereby form an oxide coating, and then, form the ceramic layer on the oxide layer since an improved diffusion barrier function can be realized by such provision of the oxide layer.

The diffusion barrier layer may preferably have a thickness of at least about 0.1 μm, and more preferably, a thickness of at least about 0.3 μm for full exertion of the diffusion barrier effect. When the diffusion barrier layer is too thick, gas permeation will be suppressed and this may cause decrease in the amount of gas permeation, and therefore, the thickness is preferably about 2 μm at most, and more preferably about 1 μm at most. In addition, since the diffusion barrier layer is provided to prevent movement of the metal component in the sintered article toward the gas permselective membrane, the diffusion barrier layer is preferably formed only on the surface of the sintered particles without blocking the opening between the sintered particles as shown in FIG. 1 in microscopic scale.

The gas separation filter of the present invention is formed by forming gas separation membrane C on the supporting base comprising the sintered multilayer structure on the side of layer B. The gas separation membrane C may comprise a membrane of Pd or an alloy thereof, or a membrane of Ti, Zr, V, Nb, or Ta, or an alloy thereof. Depending on the type of the gas to be separated by the membrane, the gas separation membrane C may also be selected from zeolite membranes, carbon membranes, inorganic organic hybrid silica membranes, and amorphous silica membranes.

The gas separation membrane C is not particularly limited for its thickness. However, the gas separation membrane C may preferably have a thickness of 1 μm to 12 μm, and more preferably 5 μm to 8 μm to simultaneously realize sufficient strength as a gas separation membrane and sufficient gas permeation.

The method which may be employed in producing the membrane of Pd or an alloy thereof, or the membrane of Ti, Zr, V, Nb, or Ta, or an alloy thereof include sputtering or arc ion plating as described above.

The zeolite membrane may be formed by any of the conventional methods that have been used in forming such a membrane, for example, by the procedure wherein a sol or a gel is applied on the supporting base, and the thus applied sol or gel is subjected to hydrothermal treatment to thereby synthesize the zeolite membrane; or a procedure wherein the supporting base is immersed in the sol adapted for synthesis, and the zeolite membrane is synthesized on the supporting base by hydrothermal treatment. The starting material is a mixture of a zeolite skeleton source, an alkaline metal source, and water, which is optionally admixed with a template or a crystallizing agent.

Exemplary sources of the zeolite skeleton metal include various metals used in the production of conventional zeolite such as silica (silica colloid sol) and alumina (aluminum nitrate, boehmite sol, silica-alumina complex colloid).

Exemplary sources of the alkaline metal include sodium hydroxide and potassium hydroxide.

Exemplary templates and crystallizing agents which may be added include those which has been used in the art such as tetramethylammonium salt, tetrapropylammonium salt, tetrbuthylammonium salt, and other tetraalkyl ammonium compounds; and tetrabutylphosphinium salt, benzyltriphenylphosphinium salt, and other phosphonium compounds.

Crystal systems of the zeolite constituting zeolite membrane include A, X, Y, T, β, ZSM-5, and silicalite.

The carbon membrane may be formed by any of the conventional methods that have been used in forming such a membrane, for example, by applying a liquid thermosetting resin on the supporting base followed by carbonization. Exemplary liquid thermosetting resins include phenol resins, melamine resins, urea resins, and fran resins, and the resin maybe coated, for example, by dipping the supporting base in the solution of the thermosetting resin in an organic solvent or an aqueous solution, or by uniformly spray coating the thermosetting resin solution of aqueous solution.

The inorganic organic hybrid silica membrane and the amorphous silica membrane may be formed by any of the conventional methods that have been used in forming such membrane, for example, by a procedure wherein the supporting base is immersed for a predetermined time in a sol adapted for synthesis, and the membrane is synthesized on the supporting base by hydrothermal treatment; or a procedure wherein a sol or a gel is formed on the supporting base and then sintered. Exemplary sources of the metal and the functional group include metal alkoxides, organometallic compounds, polysilazanes, such as tetramethyl orthosilicate, tetraethyl orthosilicate, tetrabutyl orthosilicate, dimethoxyphenylsilane, diethoxyphenylsilane, zirconium tetra-t-butoxide.

The supporting base for gas separation membrane and the gas separation filter of the present invention are not particularly limited for their shape and structure as long as the outer diameter and the length are within the ranges as specified above, and they may be designed to have cylindrical, elliptic cylindrical, polyhedral cylindrical, or any other shape depending on the shape and the structure of the gas separation apparatus. A cylindrical filter may be the most typical shape of the gas separation filter which may be used in combination with the current commercial gas separation apparatus. The sides on which the layers A and B are formed should also be determined depending on whether the gas of interest is to be passed from the interior to the exterior of the cylinder, or from the exterior to the interior of the cylinder for selection.

In the present invention, the average particle diameter, the maximum particle diameter, and the percentage of open area of the sintered particles may be determined by taking a picture of the surface of the sintered article with a light microscope at a magnitude of ×1000, and evaluating ten fields with the size of 75 mm×95 mm. In the picture, contour of each sintered particle was marked, and it was then found that the particles have hardly grown and the particle shape and size of the staring material were substantially maintained. Since the sintered article is porous, particles were sufficiently identifiable from each other. The average particle diameter (Fullman method), the maximum particle diameter, and the percentage of open area were evaluated by the procedures as described below by referring to the resulting picture.

The average particle diameter was determined by the following formula:

average particle diameter (D)=(4/π)×(NL/NS)

wherein NL is the number of particles hit by any straight line on the picture plane per unit length of the straight line, and NS is the number of particles in any unit area.

The percentage of open area was determined by the formula:

Open area (%)=[(total area of the picture)−(area occupied by the particles)/(total area of the picture)]×100

The relative density was calculated from the size (volume) and the weight of the sintered article by using the true density of 7.8 g/cm³.

### EXAMPLES

Next, the present invention is described in further detail by referring to the following Examples, which by no means limit the scope of the present invention. The present invention may be modified or varied within the scope defined in the claims and such modification and variation are within the technical scope of the present invention.

### Example 1

### Influence of Ejection Pressure in the Extrusion Molding

A supporting base in the form of a tube of sufficient length and small diameter comprising a sintered porous metal of bilayer structure was experimentally produced. The metal powder used was stainless steel powder, and the supporting bases were produced by using SUS316L, SUS310L, and SUS430L. Since the results were similar for SUS316L, SUS310L, and SUS430L, the results for the one using SUS316L are described in this Example.

The powder used for the exterior layer was the one with an average particle diameter of 4 μm or 8 μm (of course, with the maximum particle diameter of 45 μm or less), and the powder used for the interior layer was the one with an average particle diameter of 10 μm or 45 μm. Both powders were substantially spherical in shape with an aspect ratio of less than 2. To each of these powders were added Metolose as a binder and distilled water, and the exterior layer mixture was charged in a single screw vacuum kneading extruder, Model FM-P20E (manufactured by Miyazaki Iron Works Co., Ltd.), and the interior layer mixture was charged in a single screw vacuum kneading extruder, Model FM-P30 (manufactured by Miyazaki Iron Works Co., Ltd.). The binder was added at an amount of 30% by volume in the case of the interior layer mixture, and at an amount of 60% by volume for the exterior layer mixture. In each single screw vacuum kneading extruder, the mixture charged was kneaded with deaeration to produce raw materials a and b. As shown in FIG. 2, these raw materials a and b were charged in raw material inlets 12 and 13 of die 1 from nozzles 2 and 3, respectively at ejection pressures P1 and P2, and then extruded from outlet 15 of the die 1. The extruded cylindrical raw material was cut at a length of 100 mm, to produce the molded articles.

Tables 1 and 2 show the molding conditions and test results for the molded articles. The resulting molded articles were observed for their cross section, and evaluated by the following criteria. Namely, those having constant thickness of each layer in the bilayer structure with the exterior layer of adequate thickness were evaluated “pass”, and those which failed to exhibit the bilayer structure was evaluated “fail¹⁾”. Those wherein the exterior layer had a thickness equal to or exceeding ½ of the wall thickness (total thickness including all layers) were evaluated “fail²⁾”, those with a bilayer structure but with inconsistent thickness were evaluated “fail³⁾”, and those with inconsistent wall thickness were evaluated “fail⁴⁾”.

TABLE 1

| | Average particle | Average particle | Outer diam./ | Length of | Ejection pressure | Ejection pressure | |
|---|---|---|---|---|---|---|---|
| | diam. of powder | diam. of powder | inner | molded | of outer | of inner | |
| | for outer layer (μm) | for inner layer (μm) | diam. (mm) | article (mm) | layer (MPa) | layer (MPa) | Results |
| Example 1-1 | 4 | 10 | 15/10 | 100 | 4 | 5 | Pass |
| Example 1-2 | 4 | 10 | 15/10 | 100 | 2.5 | 5 | Pass |
| Example 2 | 4 | 10 | 15/10 | 100 | 5 | 5 | Pass |
| Comparative | 4 | 10 | 15/10 | 100 | 6 | 5 | Fail²⁾ |
| Example 1 | | | | | | | |
| Comparative | 4 | 10 | 15/10 | 100 | 6 | 5 | Fail²⁾ |
| Example 2-1 | | | | | | | |
| Comparative | 4 | 10 | 15/10 | 100 | 2 | 5 | Fail¹⁾ |
| Example 2-2 | | | | | | | |
| Example 3 | 4 | 10 | 15/10 | 100 | 12 | 12 | Pass |
| Comparative | 4 | 10 | 15/10 | 100 | 20 | 20 | Fail⁴⁾ |
| Example 3 | | | | | | | |
| Example 4 | 4 | 10 | 15/10 | 100 | 0.5 | 0.5 | Pass |
| Comparative | 4 | 10 | 15/10 | 100 | 0.1 | 0.1 | Fail³⁾ |
| Example 4 | | | | | | | |
| Example 5 | 8 | 10 | 15/10 | 100 | 5 | 5 | Pass |
| Example 6 | 8 | 10 | 15/10 | 100 | 5 | 6 | Pass |
| Comparative | 8 | 10 | 15/10 | 100 | 6 | 5 | Fail²⁾ |
| Example 5 | | | | | | | |
| Comparative | 8 | 10 | 15/10 | 100 | 6 | 5 | Fail²⁾ |
| Example 6 | | | | | | | |
| Example 7 | 8 | 10 | 15/10 | 100 | 12 | 12 | Pass |
| Comparative | 8 | 10 | 15/10 | 100 | 20 | 20 | Fail⁴⁾ |
| Example 7 | | | | | | | |
| Example 8 | 8 | 10 | 15/10 | 100 | 0.5 | 0.5 | Pass |
| Comparative | 8 | 10 | 15/10 | 100 | 0.1 | 0.1 | Fail³⁾ |
| Example 8 | | | | | | | |
| Example 9 | 4 | 45 | 15/10 | 100 | 5 | 5 | Pass |
| Example 10 | 8 | 45 | 15/10 | 100 | 5 | 5 | Pass |

TABLE 2

| | | Average particle | | | Ejection | Ejection | |
|---|---|---|---|---|---|---|---|
| | Average particle | diameter of powder | Outer | Length of | pressure of | pressure of | |
| | diameter of powder for | for inner layer | diameter/inner | molded | outer layer | inner layer | |
| | outer layer (μm) | (μm) | diameter (mm) | article (mm) | (MPa) | (MPa) | Results |
| Example 11 | 4 | 10 | 6/4 | 100 | 4 | 5 | Pass |
| Example 12 | 4 | 10 | 6/4 | 100 | 12 | 12 | Pass |
| Comparative | 4 | 10 | 6/4 | 100 | 20 | 20 | Fail⁴⁾ |
| Example 9 | | | | | | | |
| Example 13 | 4 | 10 | 6/4 | 100 | 0.5 | 0.5 | Pass |
| Comparative | 4 | 10 | 6/4 | 100 | 0.1 | 0.1 | Fail³⁾ |
| Example 10 | | | | | | | |
| Example 14 | 8 | 10 | 6/4 | 100 | 4 | 5 | Pass |
| Example 15 | 8 | 10 | 6/4 | 100 | 12 | 12 | Pass |
| Comparative | 8 | 10 | 6/4 | 100 | 20 | 20 | Fail⁴⁾ |
| Example 11 | | | | | | | |
| Example 16 | 8 | 10 | 6/4 | 100 | 0.5 | 0.5 | Pass |
| Comparative | 8 | 10 | 6/4 | 100 | 0.1 | 0.1 | Fail³⁾ |
| Example 12 | | | | | | | |
| Example 17 | 4 | 45 | 6/4 | 100 | 4 | 5 | Pass |
| Example 18 | 8 | 45 | 6/4 | 100 | 4 | 5 | Pass |

As apparent from the results shown in Tables 1 and 2, extrusion of a straight tube with a small diameter having a length of 100 mm or more could be easily extruded in Examples 1-1, 1-2, and 2 to 18 wherein the exterior layer was ejected at a pressure equal to or less than the pressure used for the ejection of the interior layer. In such articles, thickness of the layers of the bilayer structure was constant and the exterior layer had an adequate thickness. Comparative Examples 3, 7, 9, and 11 are cases wherein the exterior layer was ejected at the same pressure as the interior layer, but at an excessively high molding pressure (ejection pressure), and total layer thickness (wall thickness) was inconsistent. In Comparative Examples 1 to 12 (excluding Comparative Examples 2-2, 3, 7, 9, and 11) wherein the exterior layer was ejected at a pressure higher than the interior layer, the resulting product was practically unusable since they either lacked the bilayer structure, or even if the bilayer structure could be obtained, the exterior layer was excessively thick with the thickness equal to or exceeding ½ of the wall thickness (total layer thickness) or the exterior layer obtained had inconsistent thickness. In Comparative Example 2-2 wherein the exterior layer was ejected at a pressure less than ½ of the pressure used for the ejection of the interior layer, the product failed to show the bilayer structure, and hence, being far from practical for use as a supporting base.

### Example 2

### Influence of the Binder Content

Raw materials having varying content of Metolose (a binder) were prepared, and these materials were molded under the conditions used in Examples 1-1 as described above. The molded articles were dried in a roller dryer with dry air stream of 150° C. for 10 minor longer, debinded in 75% H₂-25% N₂atmosphere or 100% H₂ atmosphere at 600° C. for 4 hours, and then sintered at 900° C. for 1 hour to thereby produce a cylindrical sintered article (without forming any separation membrane on the surface of the sintered article). The thus produced cylindrical sintered article was closed at one end with a plug, and at the other end with a blind plug having a branch tube by brazing or by using an adhesive for use in the measurement of the gas permeability of the sintered article. More specifically, the branch tube was connected with a vacuum pump, and the air in the sintered article was evaluated until the interior pressure of the molded article reached the constant level. This pressure P was measured with a vacuum gauge, and gas (air) permeation q was determined by the following formula:

q=P×Q/A

wherein q is the gas permeation of the sintered article (L/(cm²·min)), P is the interior pressure (atm) of the molded article, Q is throughput (L/min) of the vacuum pump, and A is the exterior surface area (cm²) of the sintered article. The: unit “L” means liter.

Table 3 shows the binder content, relative density of the interior layer of the resulting article, gas permeation of the sintered article, and the shape of the sintered article. The relative density of the interior layer of the sintered article was measured by the method as described above by using a sintered article solely comprising the interior layer, namely, a mono-layer porous support from the same raw material under the same conditions.

TABLE 3

| | Binder content | Relative density of | Gas permeation | |
|---|---|---|---|---|
| | (% by volume) | the interior layer (%) | (L/cm² · min) | Shape of the sintered article |
| Example 19 | 35 | 65 | 1.0 | Good |
| Example 20 | 45 | 55 | 1.1 | Good |
| Example 21 | 50 | 50 | 1.1 | Good |
| Example 22 | 60 | 40 | 1.2 | Good |
| Example 23 | 70 | 30 | 1.3 | Good |
| Comparative | 75 | 25 | — | Excessive deformation |
| Example 13 | | | | |
| Comparative | 90 | 10 | — | Could not be sintered |
| Example 14 | | | | |

As evident from the results shown in Table 3, relative density of the interior layer can be controlled by adjusting the binder content. In Comparative Examples 13 and 14 wherein the relative density was less than 30%, the gas permeation could not be evaluated since the sintered article experienced excessive deformation or the sintered article could not be formed. In contrast, in Examples 19 to 23 wherein the relative density was at least 30%, the sintered article exhibited good shape with no deformation, and the gas permeation (gas flow rate per unit crosssectional area) was also sufficient. Accordingly, an improved gas permeability is achieved by the present invention compared to the conventional products simultaneously with the availability of producing the product with a smaller diameter and an increased length.

### Example 3

### Formation of Zeolite Membrane

(1) Water, sodium aluminate, and sodium hydroxide was placed in a plastic container, and the mixture was stirred at room temperature for 2 hours. To the mixture was added water glass, and stirring was continued for another 3 hours at room temperature to produce a uniform white aluminosilicate gel. The compositional ratio was 3.6 for SiO₂/Al₂O₃, 1.4 for Na₂O/SiO₂, and 50 for H₂O/Na₂O in molar ratio. In the resulting gel was immersed the sintered article of Example 1 as described above which had been subjected to seed crystal treatment, and hydrothermal synthesis was carried out in an oil bath at 95° C. for 24 hours. The resulting samples were washed with distilled water, and dried. Formation of X zeolite membrane was confirmed by XRD measurement and observation under SEM.

(2) Water, sodium aluminate, and sodium hydroxide was placed in a plastic container, and the mixture was stirred at room temperature for 2 hours. To the mixture was added water glass, and stirring was continued for another 3 hours at room temperature to produce a uniform white aluminosilicate gel. The compositional ratio of the gel was 25 for SiO₂/Al₂O₃, 0.88 for Na₂O/SiO₂, and 45 for H₂O/Na₂O in molar ratio. The resulting gel was aged for 16 hours, and in this gel was immersed the sintered article of Example 1 as described above which had been subjected to seed crystal treatment, and hydrothermal synthesis was carried out in an oil bath at 100° C. for 5 hours. The resulting samples were washed with distilled water, and dried. Formation of Y zeolite membrane was confirmed by XRD measurement and observation under SEM.

### Example 4

### Formation of Carbon Membrane

The sintered article of Examples 1-1 (the molded article of raw material Examples 1 sintered under the conditions of Examples 2) was closed by plugging both ends to prevent entering of the liquid in the tube, and immersed in a mixed solution of phenol resin (Resitop PL-2211 manufactured by Gun Ei Chemical Industry Co., Ltd) and methanol (5/3, mass ratio). After removing from the solution, the article was heated at a rate of 1° C./min to a temperature of 300° C. to 500° C., and maintained at this temperature for 6 hours. The temperature was reduced to 200° C., and maintained at this temperature for another 2 hours and gradually cooled to room temperature. Formation of a carbon membrane was confirmed by observation under SEM.

### Example 5

### Formation of Inorganic Organic Hybrid Silica Membrane

In a Teflon container (Teflon, registered trademark) were placed the starting materials of dimethoxyphenylsilane/tetraethyl orthosilicate/NaOH/methanol at a compositional ratio of 4/1/0.4/10 (molar ratio), and the mixture was stirred at 30° C. for 1 hour. The resulting precipitate was collected, and in this precipitate was immersed the sintered article of Examples 1-1 (the molded article of raw material Examples 1 sintered under the conditions of Examples 2) which had been closed with plugs as described above, and article was sintered at 300° C. to 400° C. for 5 hours. Formation of an inorganic organic hybrid silica membrane was confirmed by AES (Auger electron spectroscopy). XRD measurement, and observation under SEM.

### Example 6

### Formation of Amorphous Silica Membrane

In a Teflon container (Teflon, registered trademark) were placed the starting materials of tetraethyl orthosilicate/NaOH /methanol at a compositional ratio of 5/0.4/10 (molar ratio), and the mixture was stirred at 30° C. for 5 minutes. In this mixture was immersed the sintered article of Examples 1 which had been closed with plugs as described above, and the article was left to stand at 90° C. for 1 hour. After removing the article, the article was sintered at 300° C. for 5 hours. Formation of an amorphous silica membrane was confirmed by XRD measurement, and observation under SEM.

What is claimed is:

1. A supporting base for gas separation membrane comprising a multilayer cylinder of porous sintered metal, wherein
the layer of the multilayer structure on the side in contact with the separated gas comprises a porous sintered metal having a relative density of at least 30% and being made of particles to be sintered having an average particle diameter of at least 10 μm;
the layer of the multilayer structure on the side of the gas separation membrane formation comprises a porous sintered metal made of particles to be sintered having an average particle diameter of 8 μm or less, and a maximum particle diameter of 45 μm or less and has a percentage of open area of at least 30%; and
said multilayer cylinder of porous sintered metal has an outer diameter of 15mm or less, and a length of 100 mm or longer.

2. The supporting base for gas separation membrane according to claim 1 wherein said supporting base for gas separation membrane is the one produced by sintering particles having an aspect ratio of less than 2.

3. The supporting base for gas separation membrane according to claim 1 wherein a reaction barrier layer or a diffusion barrier layer is formed on the surface of the sintered metal on the side of the gas separation membrane formation.

4. The supporting base for gas separation membrane according to claim 1 wherein ###

5. A method for producing the supporting base for gas separation membrane of claim 1 comprising the steps of
continuously extruding raw metal powder materials corresponding to each constituent layer of said multilayer structure in the order starting from the raw metal powder material constituting the innermost layer to the raw metal powder material constituting the outermost layer such that the newly extruded layer surrounds the preceding layer to thereby produce a green cylinder of multilayer structure; and
sintering the green cylinder to produce the supporting base for gas separation membrane.

6. The method for producing a supporting base for gas separation membrane according to claim 5 wherein the raw metal powder materials corresponding to each constituent layer of said multilayer structure are extruded such that the layer extruded over the preceding layer is extruded at a pressure which is the same or lower than the pressure used in extruding the preceding layer.

7. A gas separation filter produced by forming a gas separation membrane on the supporting base for gas separation membrane of claim 1 on the side of the gas separation membrane formation.

8. A gas separation filter according to claim 7 wherein said gas separation membrane is selected from a metal membrane, a zeolite membrane, a carbon membrane, an inorganic organic hybrid silica membrane, and an amorphous silica membrane.
